(19) United States
(12) Patent Application Publication
(10) Pub. No.: US 2016/0071050 A1
(43) Pub. Date: Mar. 10, 2016

(54) Delivery Channel Management

(71) Applicant: Evan John Kaye, Short Hills, NJ (US)

(72) Inventor: Evan John Kaye, Short Hills, NJ (US)

(21) Appl. No.: 14/845,678

(22) Filed: Sep. 4, 2015

Related U.S. Application Data
(60) Provisional application No. 62/045,638, filed on Sep. 4, 2014.

(51) Int. Cl. G06Q 10/08; G08G 1/00; G01C 21/26; G06Q 50/12; G06Q 30/06

(52) U.S. Cl. CPC G06Q 10/083; G06Q 50/12; G06Q 30/0623; G01C 21/26; G08G 1/20; G08G 1/22

(57) ABSTRACT

The invention relates to a delivery system where delivery time is minimized by proactively moving the inventory into the delivery network and redirecting a nearby delivery carrier to the purchaser. The invention allows for a courier or common carrier, delivery person, or some other delivery service start moving the products into a specific geographic region, tracks where the products are, and allows a customer to see how quickly a certain product, or category of product, could arrive to them before they place their order, and then redirects the item to the end user once they place their order. The invention also provides a way to purchase an order from someone else before the first person receives their item such that the second person receives the item sooner and the first person receives some incentive reward for giving up their order or receiving it later.

### RELATED U.S. APPLICATION DATA

This is the non-provisional application of provisional application No. 62/045,638 filed on Sep. 4, 2014.

### FIELD OF THE INVENTION

The invention relates to a delivery system where delivery time is minimized by proactively moving the inventory into the delivery network and redirecting a nearby delivery carrier to the purchaser.

### BACKGROUND OF THE INVENTION

E-commerce operations that sell physical goods typically rely on a mail service or courier service to deliver the goods to the purchaser. Sometimes the goods are shipped directly from the manufacturer (“drop-shipped”), but usually the goods are stationed in warehouses at the time the order is placed. The goods may be proactively moved to different warehouses around the country based on predicted demand for the item so as to minimize delivery time and delivery expense. The distributing of items in this manner pushes them into an edge network of smaller distribution warehouses that are closer to the purchasers. Even though the demand for some items from those smaller warehouses can be quite predictable, the items are kept at the warehouses until the order is placed. Also, a distributor may not have warehouses that are close to the purchasers, and will keep the items in locations that are far away from the individuals ordering them until the orders are placed. For example, a distributor may choose only to keep a specific type of vacuum cleaner in their main warehouse in California even though they know that most week days they receive at least one order from New York State for that item. The delivery time may be 5 days, but the item will only leave its warehouse once the order is placed. There is no way for them to manage the process of proactively sending single boxed vacuum cleaners ready for delivery across the country in a proactive way and redirecting the vacuum cleaners to people that are ordering them in New York State. Many couriers allow for this type of redirection (albeit oftentimes with a fee), but a customer may well choose to pay this fee for receiving the item faster, and it would allow the e-retailer to garner more business in the destination state even though they do not have a presence there. If the same distributor wished to send the vacuum cleaner overnight to New York it would cost a lot more. So there are cost savings to the distributor or end user to proactively have product already on the way via a standard ground shipment using a common carrier.

On a more local scale, there has been an accelerating adoption of restaurant meal delivery services around the country. The conventional way to order a delivery from a restaurant has been to call them and place the order, but newer online platforms have emerged which allow ordering from a central site (e.g. Seamless.com). Either the order is passed to local restaurants for fulfillment using their delivery staff, or the entity which controls the platform may deploy its staff to fulfill the orders. The problem with platforms like these is that the food orders are only prepared and packaged for delivery once they come into the restaurant. As a result most delivery times range from 30-60 minutes. The deliveries may occur by foot, by bike or by car, and oftentimes delivery people will wait for a number of orders to be ready before setting out on their delivery route. Regardless of the mode of delivery, there is oftentimes additional capacity for them to take more goods, but since they do not anticipate what future orders might be coming from the area to which they are delivering, and the customers have no way to know what additional inventory the delivery people delivering in their area have available to them, they forego the opportunity to proactively carry additional inventory. Also, the systems are geared toward the opportunity for people to customize their orders, and to extensive variety in ordering. Oftentimes restaurants will have dozens of items available to order. However, the most popular items comprise 80% of the orders, so it is predictable with some degree of certainty as to which items can be prepared ahead of time.

Some services have emerged which provide a limited menu of a few items to choose from and has drivers with those items directed to orders that are placed in the area they area driving in (e.g. SpoonRocket.com). However, there is no way for delivery people of independent restaurants to fill their excess delivery capacity with items that are likely to be ordered by those on their delivery route. Furthermore, there is no platform which proactively places orders with local restaurants in anticipation of demand, and has delivery people for those restaurants, or independent delivery people pick up those orders and direct them to areas where there are orders currently placed or orders that are likely to be placed. The mere action of bringing the inventory into an area can increase demand for that item in the area. People will compromise customization for “fast food” with less customization. This has been a trend where some fast food places will prepare standard sandwiches, for example, and place them in refrigerators in the store. People frequent the store as they know they can quickly get a sandwich, and forego the customization opportunity that might be present at another store because that customization comes at the expense of time. In a similar way, if there was a way for people to know what excess inventory was being carried by delivery people in their area, and a way to purchase that inventory and direct the delivery person to them, then they would forego the opportunity to customize their order because they would be able to get their food quicker.

Biologically there are also reasons that people want their food quicker. From the time that someone starts to feel hungry and may think about ordering lunch, to the time they have some level of discomfort with the level of hunger is actually relatively short compared to the amount of time it takes to fill a delivery order in the conventional way. This is why one of the biggest challenges of the food delivery industry is speed. Customers call to complain about how long it is taking to receive their order. This is heightened by the fact that they are hungry at the time of these distress calls, so the interactions are emotionally charged. Furthermore, the mere action of looking at the menu online and deciding what to order, seems anecdotally at least, to have a physiological effect such that it increases the level of hunger. People do not want to plan what they are going to eat over an hour from now, they want to decide and start eating in a few minutes. Furthermore, we have come to expect this level of service from other industries, such as car services, where people do not want to book a car service some time in advance but rather are confident that when they want to call for a car, on Uber, for example, that one will be available.

### SUMMARY OF THE INVENTION

What is needed in the art and not previously described is a platform which does some or all of the following: (1) predicts market demand in a certain region for specific popular products; (2) automatically places orders for those products from manufacturers or distributors; (3) has a courier, delivery person, or some other delivery service start moving the products into a specific geographic region; (4) track through courier updates, or GPS reporting, or some other locating mechanism where the products are; (4) report on some type of interface to the customer how quickly certain products could arrive to them, and perhaps exactly where they are geographically; (5) redirect in some mechanism the product to the purchaser.

### DESCRIPTION OF THE FIGURES

FIG. 1 is a schematic which illustrates the flow of food from the restaurant to customer and the management platform that coordinates it.

FIG. 2 is the map page of a food ordering website with an information window showing related to a single courier.

FIG. 3 is the map page of a food ordering website with an information window showing related to a single food category.

FIG. 4 is the cart page of a food ordering website.

FIG. 5 is the delivery address page of a food ordering website.

FIG. 6 is shows the payment modal of a food ordering website.

FIG. 7 is a confirmation web page of a food ordering website.

FIG. 8 shows the login screen of a courier's mobile application.

FIG. 9 shows the Inventory screen of a courier's mobile application.

FIG. 10 shows the Add Inventory Brand List screen of a courier's mobile application.

FIG. 11 shows the Add Inventory Item List screen of a courier's mobile application.

FIG. 12 shows the Order List screen of a courier's mobile application.

FIG. 13 shows the Order Details screen of a courier's mobile application.

FIG. 14 shows an Order Item List page of a courier's mobile application.

FIG. 15 shows a map page of a courier's mobile application.

FIG. 16 shows the account page of a courier's mobile application.

FIG. 17 shows a marketing postcard highlighting the functionality and value proposition to customers.

### DETAILED DESCRIPTION OF THE PREFERRED EMBODIMENT

The invention is described in detail with particular reference to a certain preferred embodiment, but within the spirit and scope of the invention, it is not limited to such an embodiment. It will be apparent to those of skill in the art that various features, variations, and modifications can be included or excluded, within the limits defined by the claims and the requirements of a particular use.

One embodiment of the invention is for a restaurant food delivery service. This is best described by way of the following description and accompanying figures.

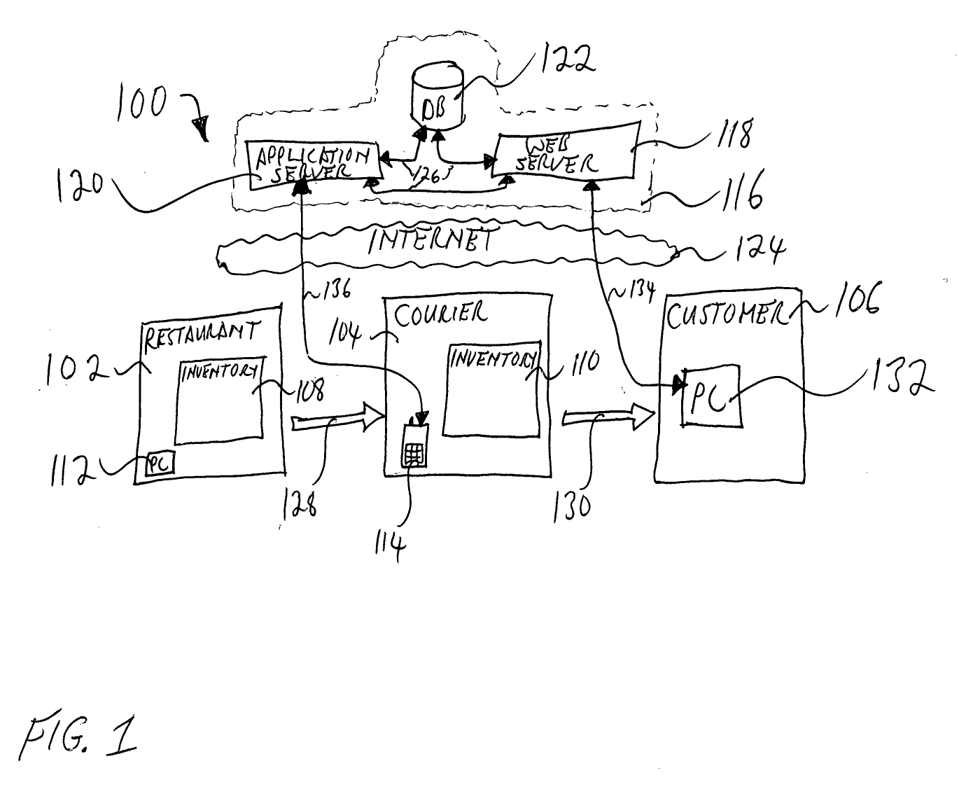

With reference now to FIG. 1, a schematic 100 is shown which illustrates the flow of food from the restaurant 102 to 128 the courier 104 to 130 the customer 106. The restaurant 102 has its restaurant inventory 108, and the courier has their courier inventory 110. The courier may transport their inventory by foot, by bicycle, by motor vehicle, or by any other means. The restaurant 102 has a desktop machine 112 through which it receives orders. The courier has a mobile phone 114 through which they manage their inventory 110, keep track of orders, report their location, and other functions. The management platform 116 comprises a web server 118, application server 120, and database 122. The customer 106 uses their client machine 132 to access 134 the web server 118 through the Internet 124. The application server 120 communicates 136 with the courier mobile phone 114 through the Internet 124. The database 122 communicates with the web server 118 and application server 120 through private network connections 126.

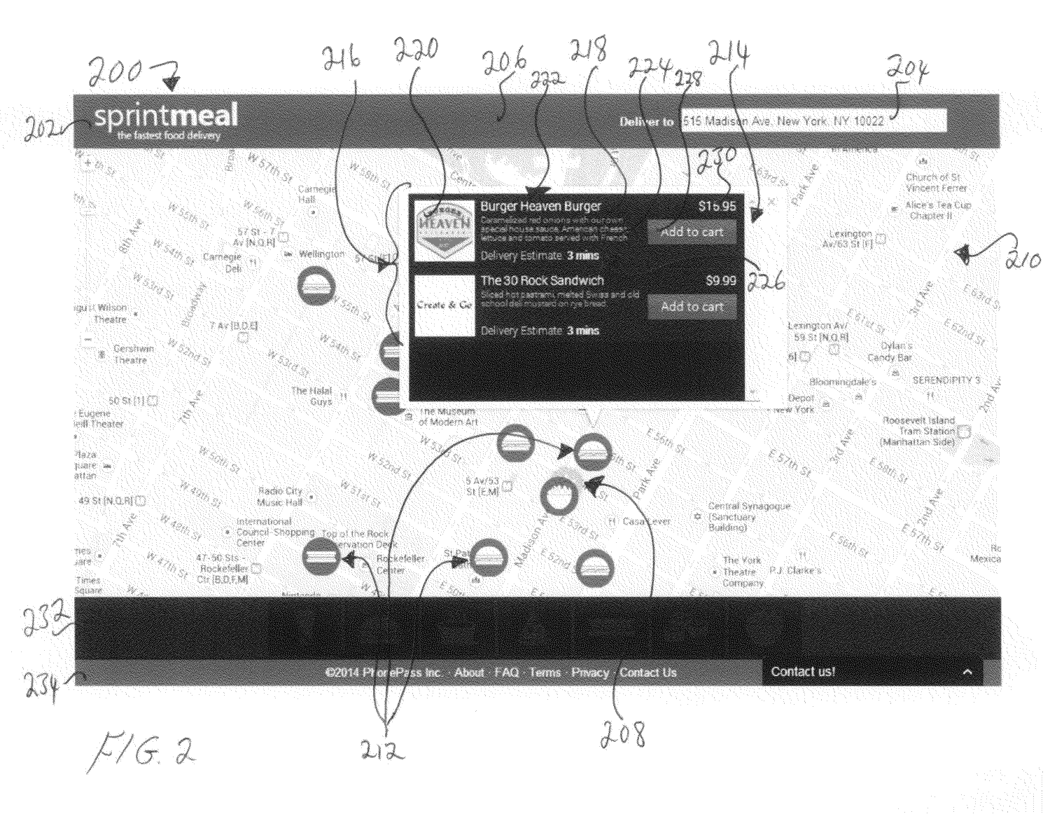

With reference to FIG. 2, a map page 200 of a food ordering website is shown which has the brand logo 202 and address field 204 in the header 206. The customer 106 of FIG. 1, types their address into the address field 204. The map page 200 then refreshes and repositions the map area 210 so that the location corresponding to the address in the address field 204 is in the center of the page, and a customer location symbol 208 is displayed in that center location. The geolocation of the address is done by a third party geolocation service, as customarily done by those with skill in the art. Furthermore that same geolocation service powers an autocomplete function of the address field 204 so that the customer 106 of FIG. 1 can easily input the address. The web page 200 then asynchronously requests couriers 104 of FIG. 1 in the region of the map area 210 and displays them as symbols 212 on the map, in positions that correspond to the actual positions of the couriers 104 of FIG. 1. Since each courier 104 of FIG. 1 may have different types of food in their inventory 110 of FIG. 1, the symbols 212 periodically change every few seconds to represent the assortment of types of meals available in that courier's inventory 110 of FIG. 1. When a customer clicks on a symbol 212 an information window 214 appears which show a listing 216 of the food inventory 110 of FIG. 1 available from that courier 104 of FIG. 1. The listing 216 shows a first item 218 which has the brand logo 220 of the restaurant which made the food item, the name 222 of the item, a description 224 of the food item, an Add to Cart button 228, the price 230, and a delivery estimate 226 which approximates how long it will take the courier 104 of FIG. 1 to reach the customer 106 of FIG. 1. The category bar 232 and footer 234 are at the bottom of the map page 200.

The aforementioned delivery estimate 226 may be a simple estimate based on the distance between the courier 104 and the customer 106 taking into account the mode of travel of the courier 104. The courier 104 might indicate through the use of a mobile app, the modality they are using to transport the food items, whether on foot, by bicycle or by car. An estimate can then be made given the distance, or through road routing, how long it will take to get there. Traffic information may also be used to predict the time it will take. Since inventory items and couriers 104 are shown on the map area 210 whether or not the courier 104 is available for redirection, or currently proceeding with one or more orders, a more sophisticated time estimate would take into account the courier's 104 current order commitments. There may be indication on the map through use of the courier's symbol 212 whether the courier 104 is available for immediate rerouting or whether they are currently delivering an order.

When many couriers 104 are operating in an area, there may also be a mechanism for the management platform 116 to have couriers 104 exchange certain items from their inventory between each other. This could be important if one courier is committed to delivering an order, but another courier close by is free to take some of the first courier's 104 inventory and deliver it to a location that is substantially far away from the first courier's 104 destination for their order. Another time that an exchange would be favorable would be for inventory replenishment. Since it is optimal that each courier 104 carry items from a number of different restaurants 102, there would be times when a single courier 104 could be directed to pick up items from a restaurant 102, and then pass them to other couriers 104 in coordinated exchanges. The management platform 116 would direct a courier 104 to a meeting point, where the second courier would meet them and give them the new inventory. All of the above commitments could be taken into account in calculating the delivery estimate 226. Also, low priority exchanges for inventory management purposes could be reprioritized or eliminated when an order comes in and therefore eliminated for delivery estimate 226 calculation.

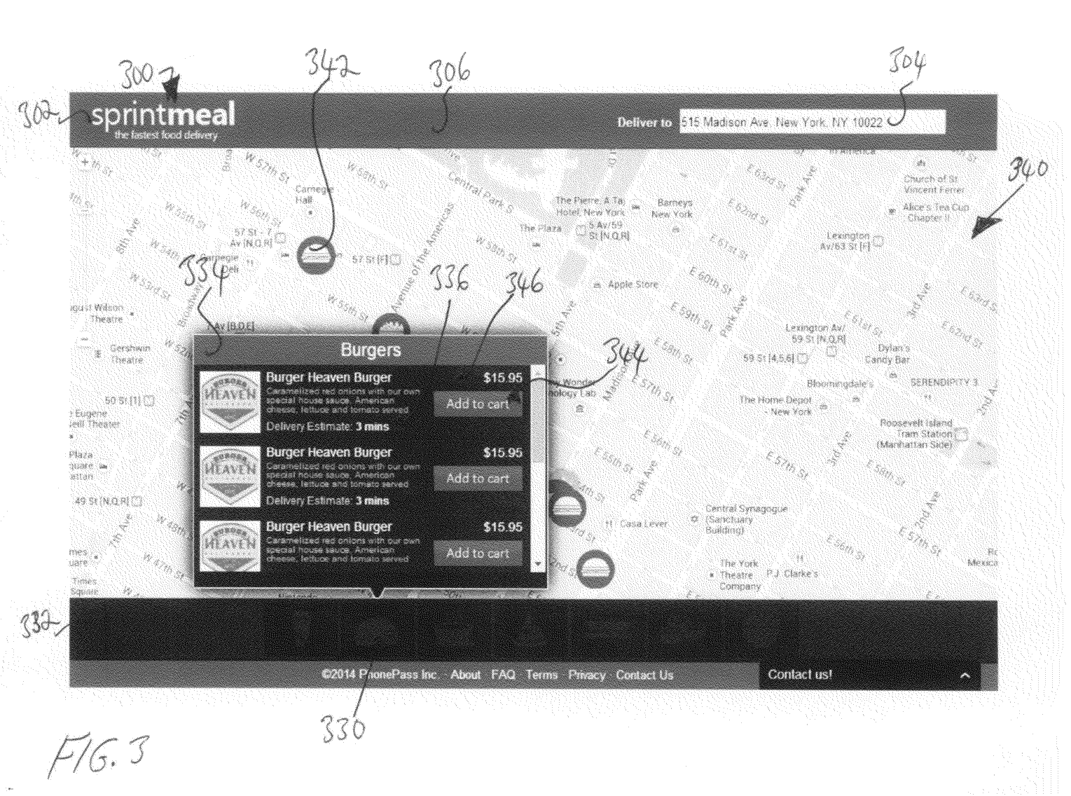

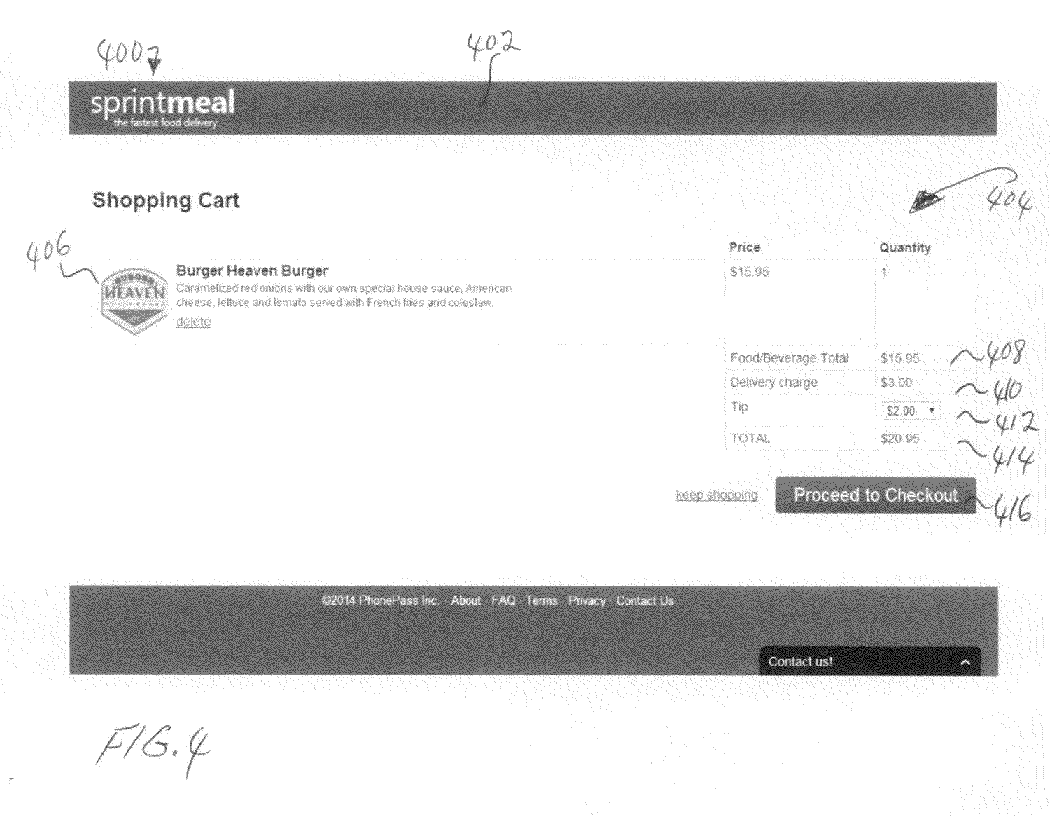

With reference to FIG. 3, the same map page 200 of FIG. 2 is shown as a map page 300 of a food ordering website which has the brand logo 302 and address field 304 in the header 306. The customer 106 of FIG. 1 has now moved their cursor over the Burger category button 330 of the category bar 332. A category information window 334 is displayed above and related to the Burger category button 330 and lists all courier inventory 110 available in the area. The items are listed ascending by delivery estimate time 336. As described above, the delivery estimate time may not always be the same as the distance from the customer 106, as more complex calculations taking into account order commitments and modes of transport are also used. When a customer 106 hovers their cursor over an item 338 in the information window, the map area 340 may move to center the related courier 104 and highlight it. This gives the customer confidence that the item they are ordering is indeed in the area and also allows them to move their cursor to the courier symbol 342 so that they can click on it and cause the information window 214 of FIG. 2 to appear to see what else that courier 104 has in their inventory 110 of FIG. 1. Knowing what else is in that courier's inventory 110 allows the customer 106 to order more than one item from the same courier 104 as opposed to many items from different couriers 104. It is more efficient if they order multiple items from the same courier, and if there are delivery fees involved for each courier that visits then they would be incentivized to maximize this efficiency. Given that there may be inventory that is readily available to a courier 104 from other couriers 104 in the area, there may be times where the delivery fees could be dropped even if the items are coming from different couriers. The management platform 116 would determine when this scenario is applicable, and that inventory may show up on a courier's inventory 110 even if they are not actually carrying it at the time but could get access to it quickly. In these cases the management platform 116 would account for this extra exchange time in the calculation of the delivery estimate 336. To order an item 346 the customer 106 clicks the Add to Cart button 344 which adds the item 346 to the customer's electronic shopping cart, and may navigate them to the cart page 400 of FIG. 4.

With reference now to FIG. 4, a cart page 400 is shown which has a header 402 and cart area 404. The cart area 404 lists an item 406 that has been added to the cart by the customer 106. A subtotal 408, delivery charge 410, tip selection 412, and total 414 line items are shown. The cart page 400 may also highlight to the customer, other items that are on the courier, or closely available to the couriers (as described above) that could be purchased by the customer without incurring any further delivery fees. The user clicks the Proceed to Checkout button 416 when they are ready to proceed with the order.

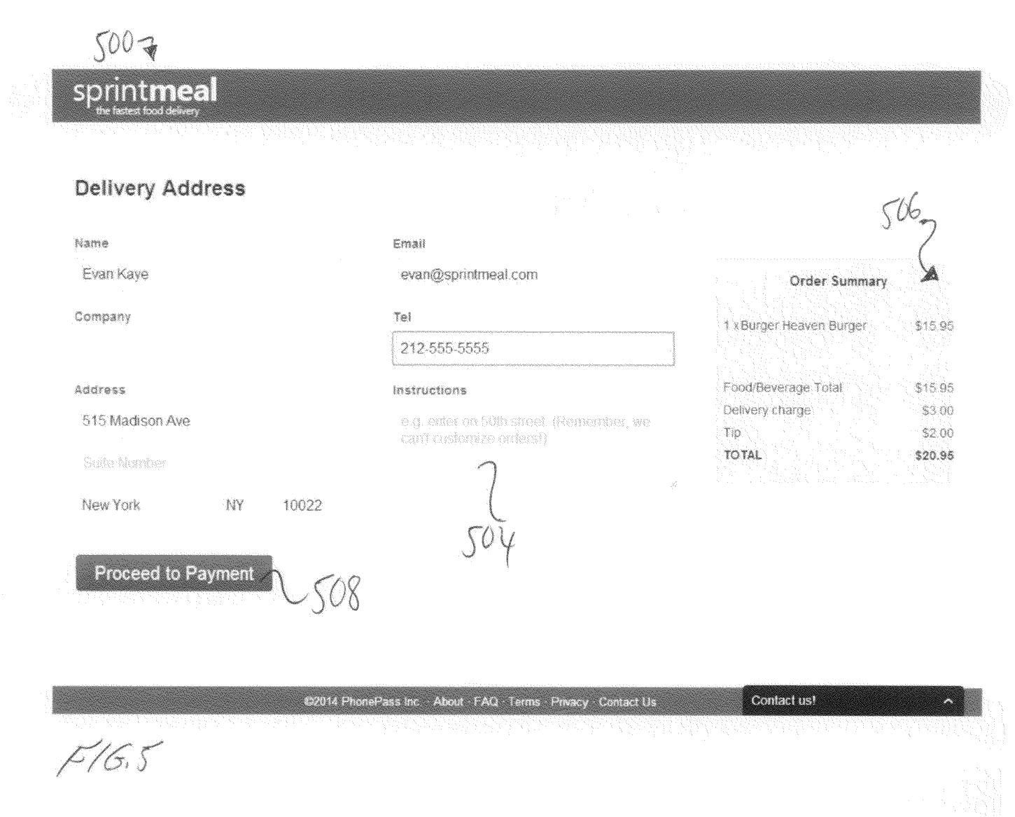

With reference now to FIG. 5 a delivery address web page 500 is shown which contains all the typical fields associated with a delivery order. The customer may choose to populate the Instructions 504 field with specific instructions about how to access the location where the delivery is to be made. A summary box 506 shows the order summary, and the customer clicks the Proceed to Payment button 508 when they are ready to pay for the order electronically.

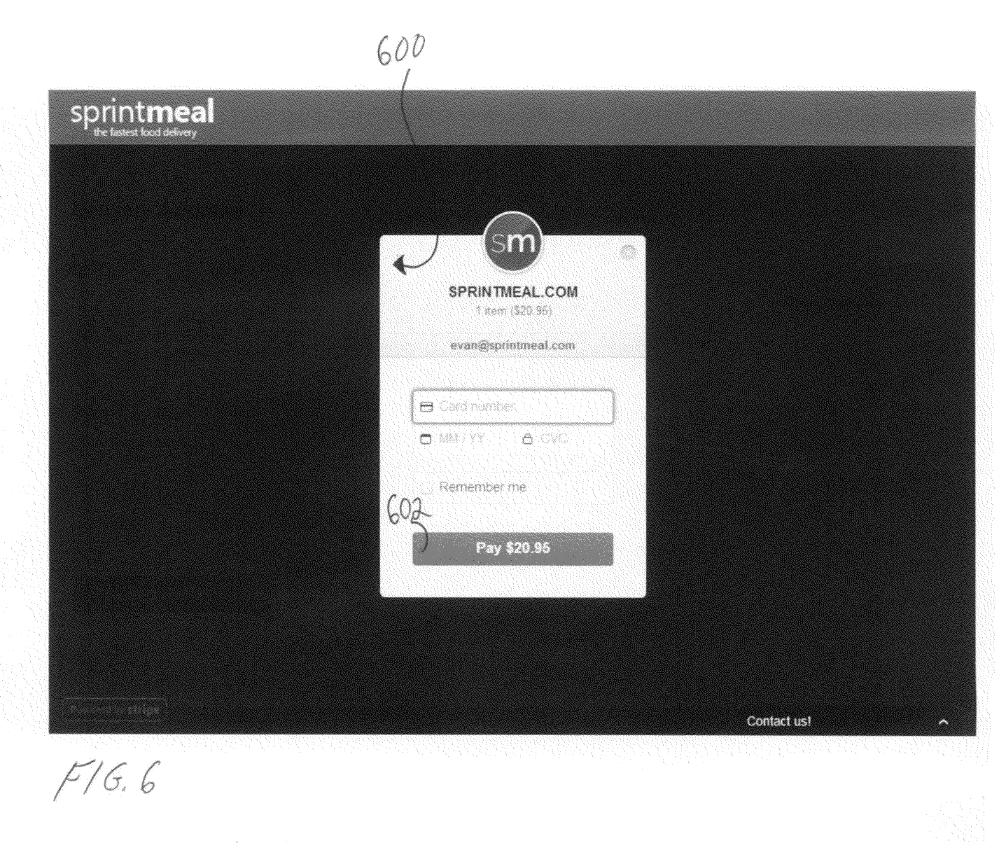

With reference now to FIG. 6, a payment modal 600 is shown which contains standard payment fields that allows a customer to enter a credit card number and associated authentication data including the expiry date and CVC code as commonly required for online credit card transactions. The customer then clicks the Pay button 602 to complete the order and initiate the delivery of the ordered items.

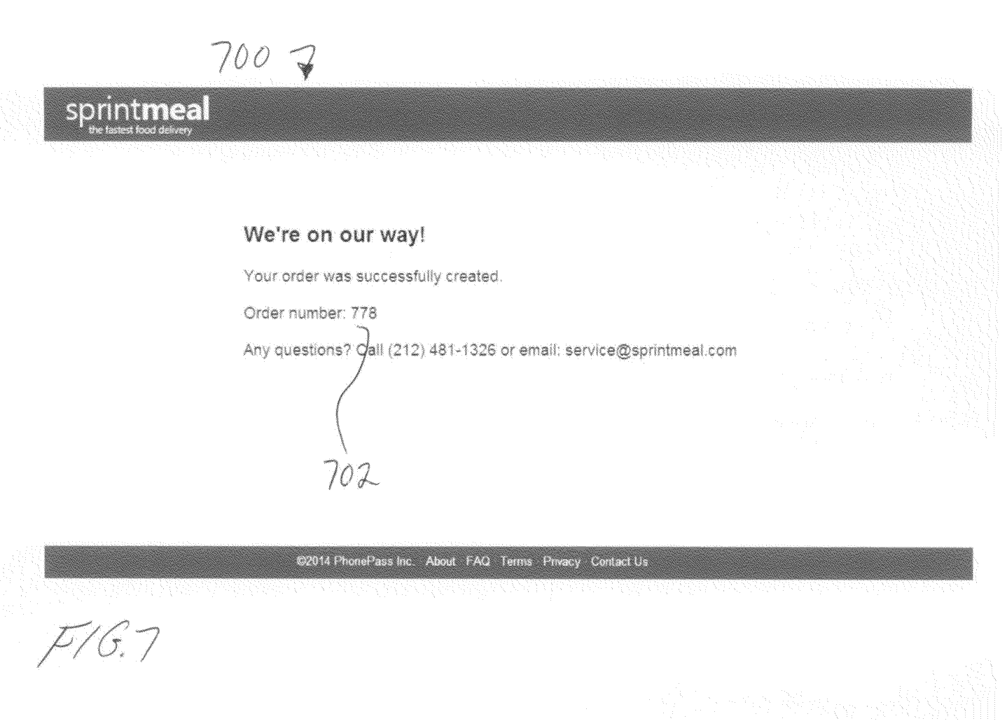

With reference now to FIG. 7 a confirmation web page 700 is shown which acknowledges to the customer that the order has been successfully placed and supplies them with an Order number 702. As is the convention with these types of electronic transactions, the display of this web page occurs concurrently with the emailing of the customer, an electronic receipt of the order.

The following figures pertain to the mobile application that the courier 104 of FIG. 1 uses to interface with the delivery service, including managing their inventory 110 of FIG. 1 and their orders.

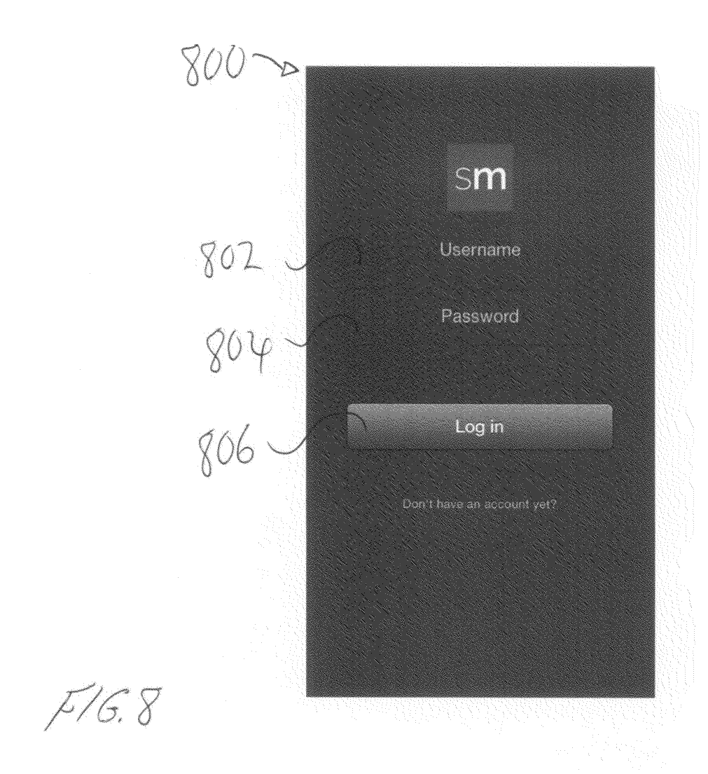

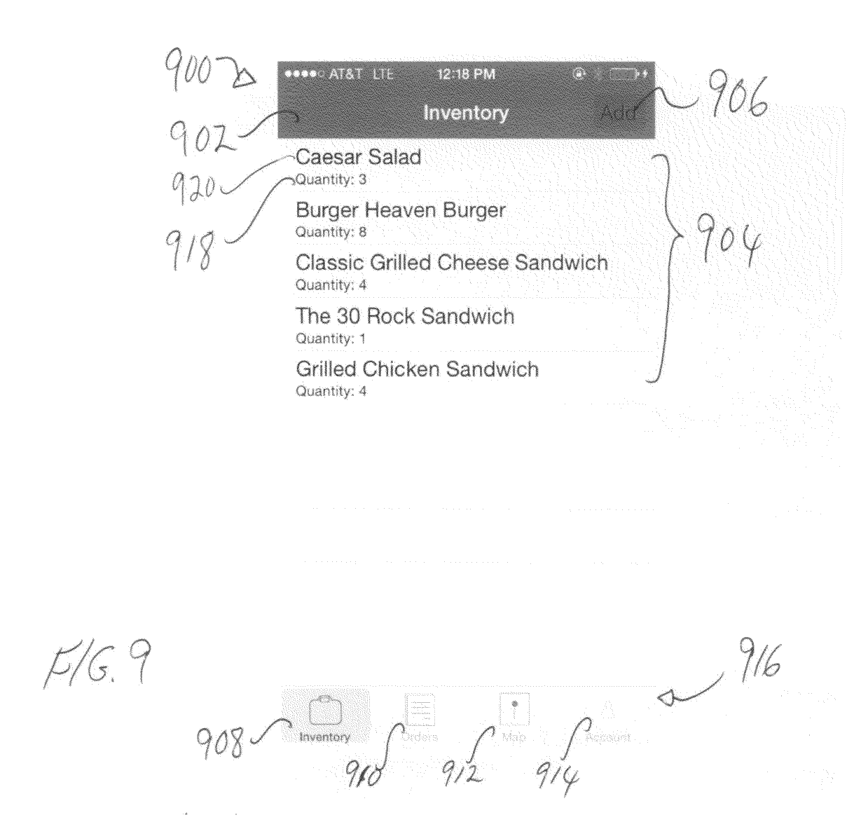

With reference now to FIG. 8, a mobile app login screen 800 is shown containing fields for the Username 802 and Password 804. The courier 104 of FIG. 1 logs into the mobile application by clicking the Log In button 806. While this preferred embodiment illustrates how a courier 104 uses a dedicated app for courier functions, it can be appreciated that the functionality of this mobile app may be incorporated into a more general mobile app that interfaces with this delivery service. The more general app may allow the user to be a customer of the delivery service as well as a supplier and courier. Once logged in, the courier 104 is shown the screen 900 of FIG. 9.

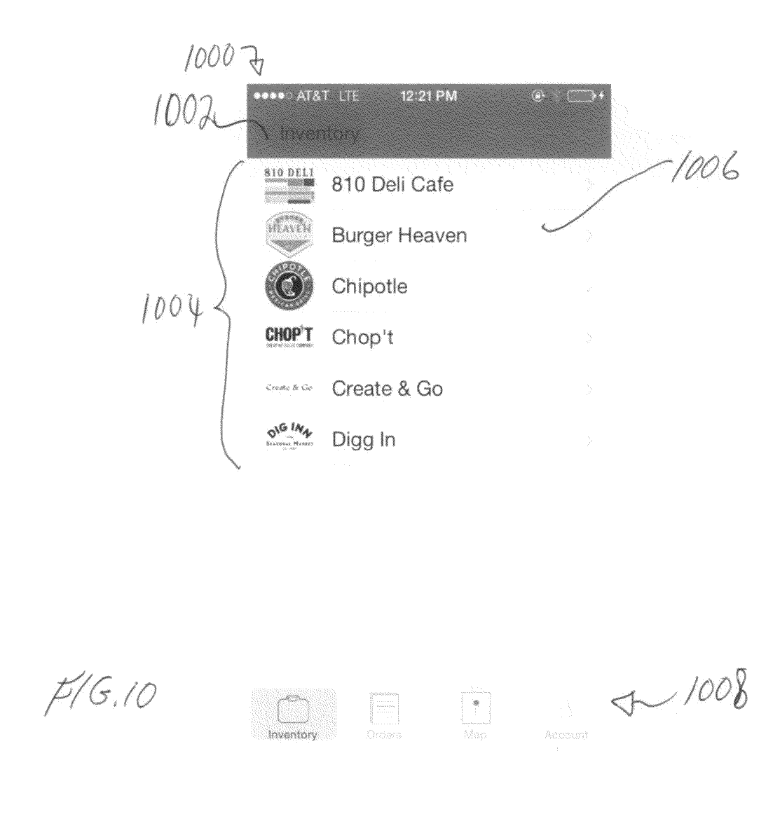

With reference now to FIG. 9, a mobile app Inventory screen 900 is shown with a header 902, inventory list 904 and tab bar 916. The tab bar is consistent throughout the mobile application and allows the courier to navigate to different parts of the application. It houses the Inventory button 908, Orders button 910, Map button 912, and Account button 914. Each item in the inventory list 904 contains a title 920 and the quantity the courier has on them 918. A courier 104 uses the Add button 906 to add inventory items to the inventory list. When they tap it they navigate to the Add Inventory Brand List screen 1000 of FIG. 10. To delete an item they can swipe across the desired item to be deleted in the item list 904 as is a convention in touch mobile apps. Orders will automatically decrease a couriers inventory, so there usually will not be a need to delete inventory, but the option exists in case an item spoils, is damaged, or added to the inventory in error.

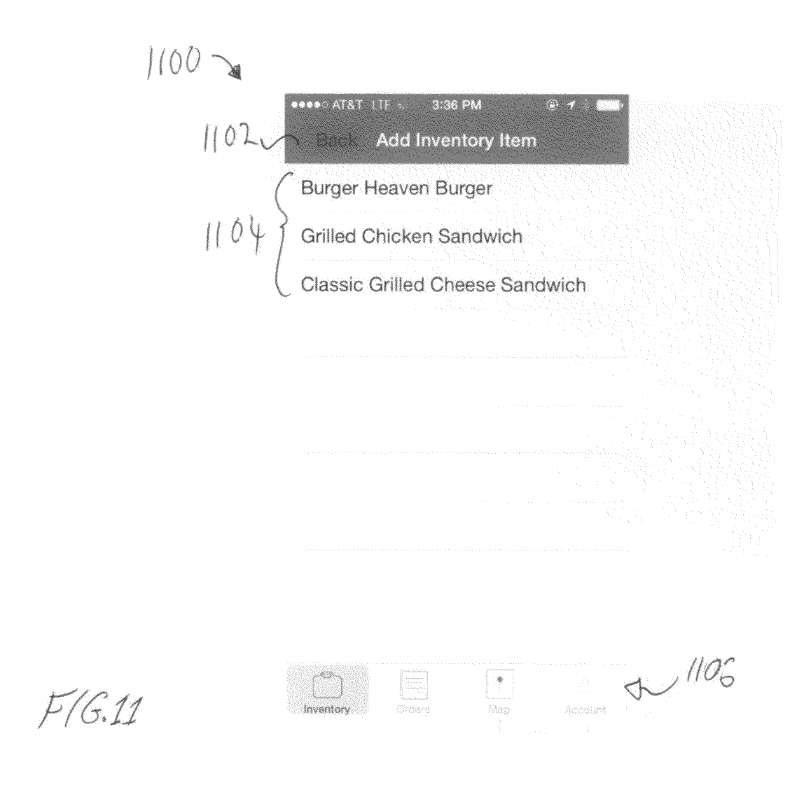

With reference now to FIG. 10, an Add Inventory Brand List screen 1000 is shown. It has a header 1002, a brand listing 1004 and a footer 1008. The courier selects an individual brand 1006 that pertains to the item they wish to add. The Add Inventory Item List 1100 of FIG. 11 is then displayed.

With reference now to FIG. 11, an Add Inventory Item List 1100 is shown with a header 1102, item list 1104, and tab bar 1106. All items in the item list 1104 are those that relate to the brand 1006 selected by the courier in FIG. 10. The courier 104 can tap any of the items in the item list 1104 and it will add one of those units to the courier's inventory 110 of FIG. 1. Using these screens the courier 104 can manually manage their inventory. A more sophisticated bulk management system can also be used when the courier 104 exchanges a bundle of items with other couriers 104, or picks up an order from a restaurant 102. Since the management platform 116 could place the orders with the restaurants 102, and is aware of the contents of the order when a courier 104 picks it up from the restaurant 102, it can automatically add a number of items to the inventory. While the inventory control screens do not allow for the tracking of discrete items in this embodiment, the tracking of the discrete items by ID codes enables further functionality that will be described below relating to the expiration of perishable item inventory.

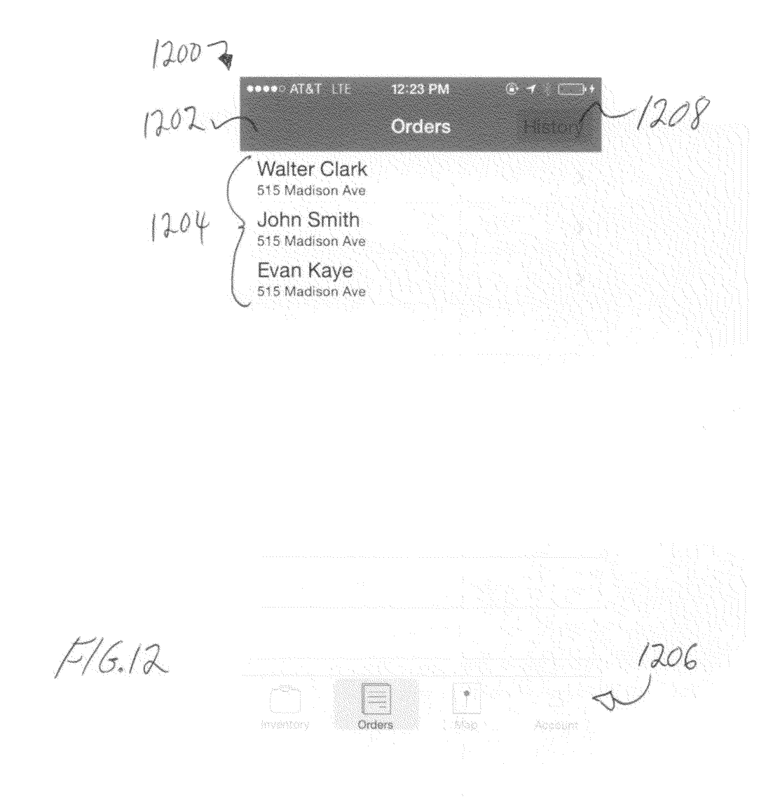

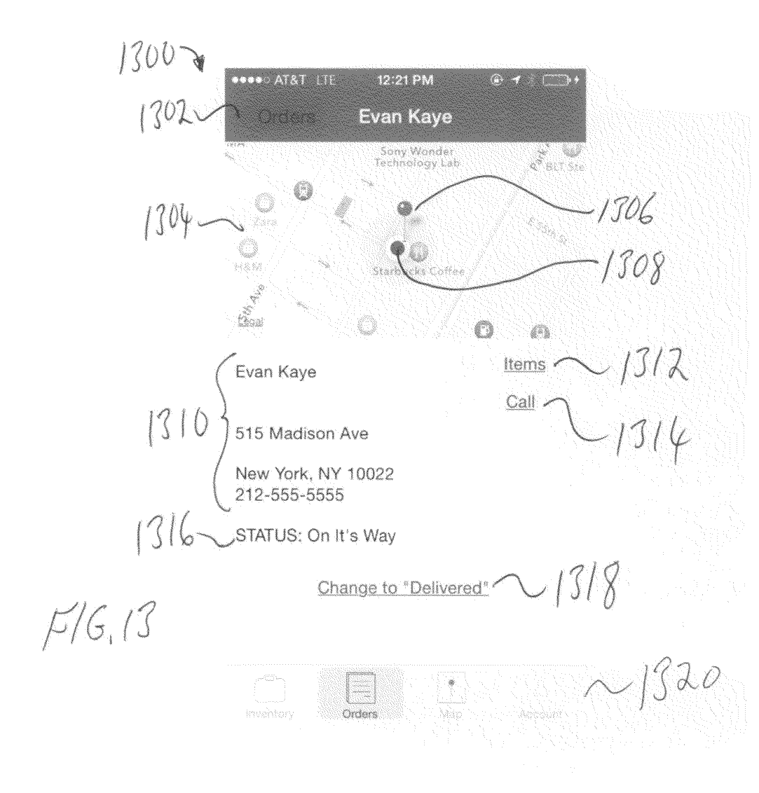

With reference now to FIG. 12 the Order List page 1200 is shown, with a header 1202, order list 1204 and tab bar 1206. The history button 1208 allows the courier 104 of FIG. 1 to see previous orders and reactivate any orders that were tagged in error as being delivered. If a courier taps any of the orders in the order list 1204 they will be shown the Order Details page 1300 of FIG. 13 pertaining to that order.

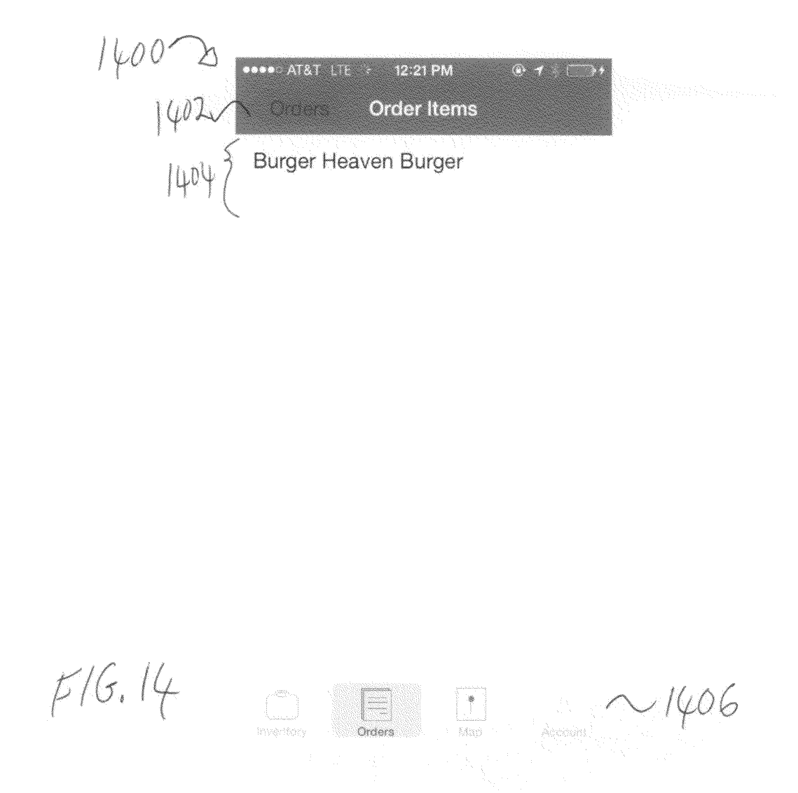

With reference now to FIG. 13 the Order Details page 1300 is shown, with a header 1302, map area 1304, delivery location 1306, courier's current location 1308, customer's details 1310, an items button 312, a call button 1314, a status label 1316, a status change button 1318, and a tab bar 1320. The courier 104 taps the items button 1312 to view a list of items included in the order as shown in the Order Item list 1404 of FIG. 14. They can also tap the call button 1314 for a call to be initiated to the telephone number of the customer 106. When the courier has delivered the order to the customer 106, they tap the status change button 1318 to change the status label 1316 from “On It's Way” to “Delivered”.

With reference now to FIG. 14, the Order Item List page 1400 is shown which pertains to an individual order. It has a header 1402, an order item list 1404, and a tab bar 1406.

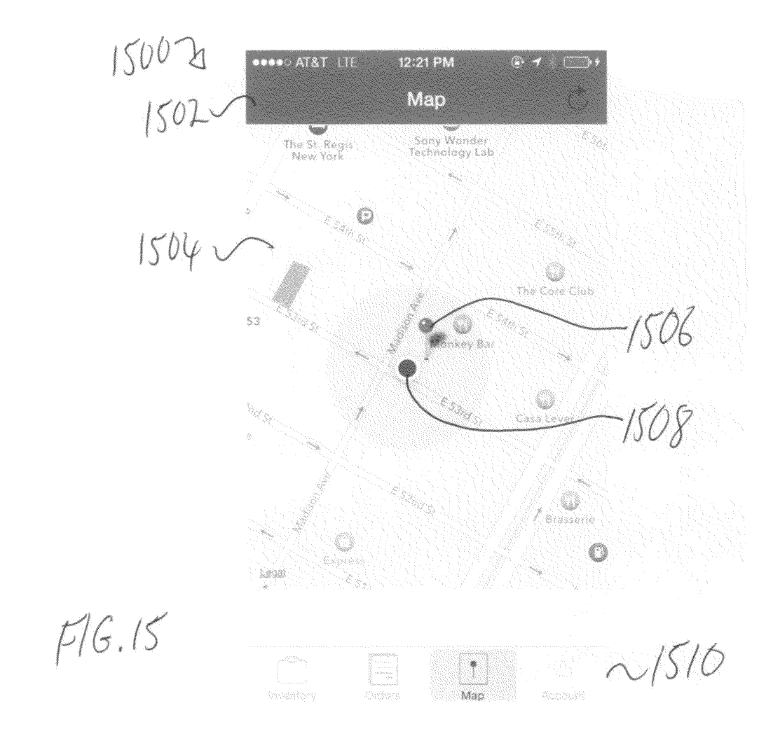

With reference now to FIG. 15, a map page 1500 is shown which depicts the locations of all the open orders. It has a header 1502, map area 1504 and tab bar 1510. The location of an order 1506 is depicted as a red marker, and the courier's current location depicted as a blue circle 1508.

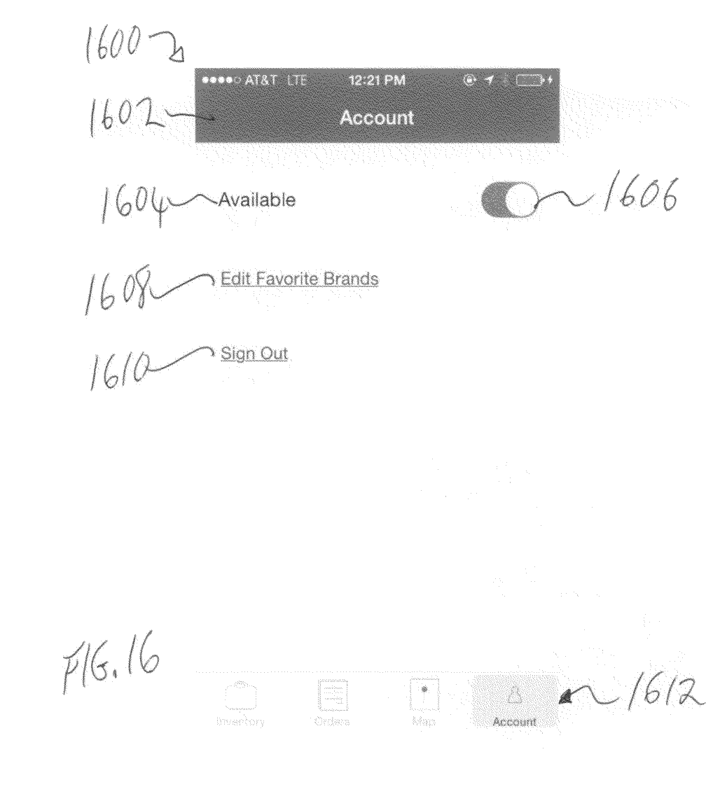

With reference now to FIG. 16, an account page 1600 is shown, with a header 1602 and tab bar 1612. It has an Available label 1604 and switch 1606 which the courier 104 uses to signal their availability to the management platform 116 of FIG. 1. When they are available to deliver orders then they switch the switch 1606 on but otherwise keep it turned off. The mobile application periodically reports the position of the courier 104 to the management platform 116 but stops reporting the position if the availability switch is turned off. The Edit Favorite Brands button 1608 allows the courier to select the brands that they most frequently deliver from a list of brands. This is particularly important for couriers that work for one, or just a few restaurants, and only deliver those brands. By selecting only those brands as favorite brands it makes it more efficient for them to add inventory as they do not have a long list of brands to choose from in the brand list 1004 of FIG. 10.

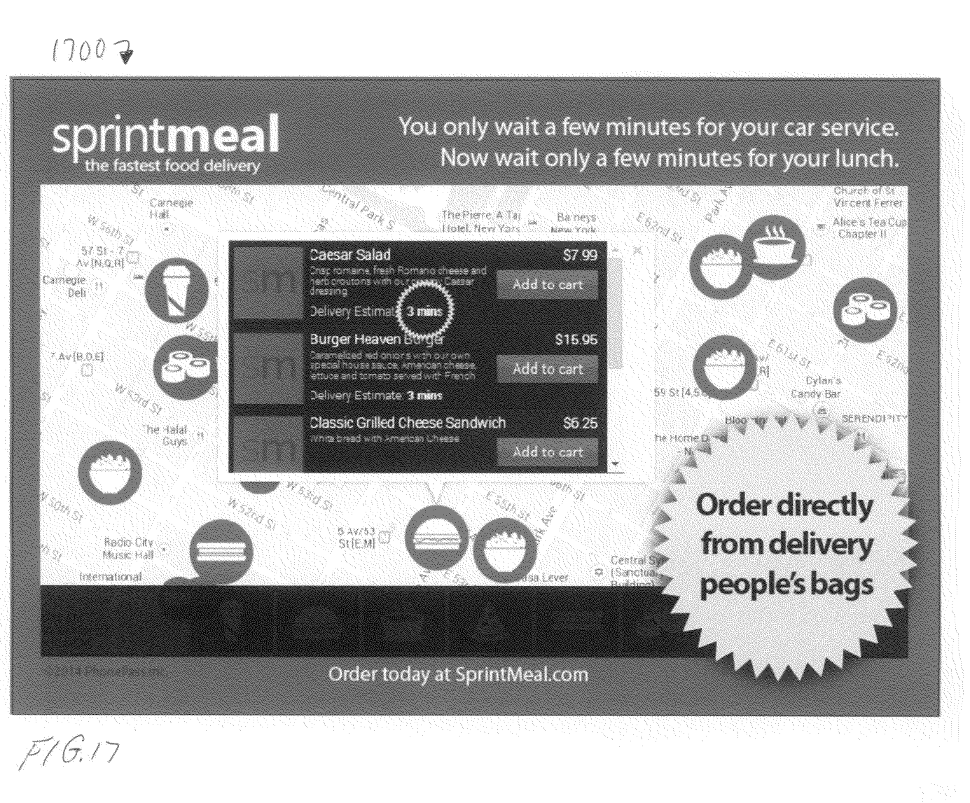

With reference now to FIG. 17, a marketing postcard 1700 is shown highlighting the functionality and value proposition to customers.

In the current embodiment where food items may be perishable, the food inventory is transported within specific temperature ranges, sometimes in insulated containers. These temperatures may be monitored by temperature devices in the containers and reported back to the management platform 116 through the mobile devices of the couriers through which the temperature devices may communicate through Bluetooth or other mechanism. In this way, the management platform can monitor the integrity and quality of the inventory. Also, each specific item in a courier's inventory may have an ID associated with it, so that the time duration on the courier can be monitored. For instance, if the courier has one hamburger in their bag, and picks up another two hamburgers from the restaurant, the first hamburger should be the first one to be delivered to a customer above the other two that have just been picked up, in a first in first out protocol as opposed to a last in first out protocol. Giving each inventory item a specific ID number also allows for elimination of items once they have been deemed to be expired. They can also be discounted as the expiry time nears.

Since couriers in this invention have inventory that is not yet sold, people that encounter the couriers, whether in the street or within their building may be interested in what inventory is available for them to purchase directly from the courier. Instead of the courier opening their bag and showing the available inventory to interested parties, which would require permits in some settings, and would not be optimal from a food item temperature management standpoint. There could be a way for a customer to search the inventory of a specific courier by referencing an ID number which the courier is wearing and entering that on the website or a mobile app. The customer could also scan a QR code on the courier which identifies the courier and navigates the user to the food ordering website of FIG. 2. The courier's current inventory would then be listed and they could purchase an item online that would then be immediately “delivered” by the courier that is already nearby.

While the preferred embodiment has been shown as a website version of the invention, it could also be similarly embodied through a mobile optimized website, or a mobile app. In a device such as a mobile phone which oftentimes nowadays is fitted with GPS tracking technology, the user would not need to necessarily enter their delivery address as a first step before being able to effectively use the map, but instead just give permission for the mobile app to access their current location through use of location data (including GPS, Wifi, and cellular signals used to triangulate location). At the time an order is placed, a customer may then input their actual delivery location, or opt for the courier 104 of FIG. 1 to deliver the order to the current location of their mobile phone. In this case, the mobile app would constantly update the courier (usually through the management platform 116) as to the mobile phone's location. Effective use cases for this scenario is where there is no defined real world location where the customer is, or if the customer is on the move, albeit slowly. For instance, using this embodiment of the invention, a customer may order something to their location when they are sitting on the beach, or in their car during traffic. Or perhaps they are running errands around the city and will be somewhere in a few block radius but do not want to wait at a specific location for the courier. In these scenarios, the customer may provide the management platform 116 with some further identifying information about themselves (for example, a photo, or a license plate number) so that the courier could more easily identify them. Also the courier would have on their mobile device a mechanism to navigate to the customer using their GPS tracking functionality, a dynamic map showing their location and their customer's current location, and perhaps the utilization of their compass functionality as is commonly used by those with skill in the art and embodied in modern mobile operating systems. This functionality may be incorporated into the courier's mobile application so that the destination point is dynamically updated. The courier should also be able to call the customer, ideally from within the app, when they are nearby so that they can effectively locate the customer. As the courier gets within a certain range of the customer's mobile device as determined by the location data, it may trigger, through the management platform 116, or directly, the devices to connect to each other directly through a direct electromagnetic link to facilitate the navigation of the courier to the customer. If the courier is using a service animal to help facilitate the delivery, then when within a certain range, the customer's mobile device and associated mobile app can be triggered by the management platform 116 to emit a high pitched signal that is distinct enough to be recognized by the service animal but inaudible to the human ear. The service animal can then be used to locate the customer (through locating their mobile phone).

An alternative embodiment of the invention could provide a marketplace for goods (new or used) whereby people that have any type of inventory for sale or rent that are immediately accessible to them can advertise the availability of such goods on the platform. In this way, the marketplace has inventory tied to locations (given by the poster's constantly updating location data from a mobile application running on their handset). When someone orders an item, that poster is notified and can immediately take it to the purchaser. There may also be an option for the purchaser to instead pick it up from the poster's location. For example, someone may want to rent a lawnmower for a couple of hours. A landscaper with a lawnmower that he has put into his online inventory on the platform, would be able to deliver to that user, the lawnmower for a rental period. Or someone may be out of flour with no local stores open, they would be able to search people's inventories around them and have flour delivered to their home. While some people's inventories on their person may be quite limited, they may have access to a set of inventory when in their car, or when they are at home. They may therefore set up inventory groups based on location. The mobile application would be aware when a user is in their car since it would be able to detect the Bluetooth link, for instance. The mobile application would be aware when the user is at home based on location data. There will always be an availability setting too, to allow the user to turn off their presence in the marketplace at will. They may also have rules determining their service level if an order is placed at night, for instance.

Since the invention focuses intensely on the availability of goods, another embodiment of the invention is an e-commerce storefront or marketplace that does not necessarily show the locations of all matching items in search results or browsing pages, but allows the user to sort results by the time it will take for the user to receive the item. As disclosed above, some items could be available for redirection through a common carrier, some items could be available for shipping from a distribution center in the standard way, others might be available for delivery to the person. An embodiment of the invention is also to commingle such results so that the customer can make the determination if they wish to pay more for getting the item sooner. They may even be given the option of purchasing the item from another user while it is still in transit the other user. In that case, either the other user has indicated that their delivery is not urgent and they are willing to have the order delayed (or give up the order and have another one delivered) for some incentive reward (cash, certificate, or other), or they may be offered the opportunity to respond to the request that someone would like to purchase that item instead and have it redirected to that new purchaser. This type of alert to the other user may come in the form of an email, text message, or push notification, but does not necessarily require that the other user consents to a delay or cancellation of their order ahead of time. They can also consent to the purchase of their order by another user at the time that the other user inquires about that order. Furthermore, an e-commerce site may allow the second user to place an order in the standard way, with an option of being notified if the order can be expedited. Once the second user places their order the notification can then go out to all those users that placed an order for the same item already that are within a similar geographic area to the second user. In this way, those original people that have ordered can get the opportunity to forego their order in order to gain some reward.

I claim:

1. A method of minimizing delivery time to an end user comprising:
proactively moving inventory items into a delivery service operation;
allowing the end user to search inventory items currently available in their geographic region; and
allowing the end user to place an order for an inventory item to be delivered to them.

2. The method of claim 1 wherein the delivery service comprises a large network of warehouses and couriers.

3. The method of claim 1 wherein the delivery service comprises individual couriers.

4. The method of claim 1 further comprising a dynamic map which shows the end user the distribution of inventory in their local geographic area.

5. The method of claim 4 wherein the dynamic map is automatically updated to substantially approximate the current location of items in inventory.

6. The method of claim 1 wherein the search functionality includes the ability to filter by item category.

7. The method of claim 1 wherein a destination is picked for each inventory item at the time the inventory item is moved to the delivery service.

8. The method of claim 7 wherein the destination is changed based on the new recipient of the item.
